(19) United States
(12) Patent Application Publication
(10) Pub. No.: US 2026/0225823 A1
(43) Pub. Date: Aug. 6, 2026

(54) CONTAINER TREATMENT FACILITY WITH CONTAINER DISCHARGE FUNCTIONALITY

(71) Applicant: KRONES AG, Neutraubling (DE)

(72) Inventors: Niklas EGERER, Riedenburg (DE); Hans-Juergen FLEISCHMANN, Steinberg am See (DE); Thomas HOELLRIEGL, Teublitz (DE); Juergen KOLLER, Walderbach/Kirchenrohrb (DE); Ludwig SCHEIDLER, Siegenburg (DE); Paul BRINSTER, Saal a. D. (DE); Konrad SENN, Alteglofsheim (DE); Sascha BAUER, Woerth an der Donau (DE); Nicolas NUEBEL, Regensburg (DE); Toni NEUMANN, Pressath (DE)

(21) Appl. No.: 19/465,287

(22) Filed: Jan. 30, 2026

(30) Foreign Application Priority Data
Jan. 31, 2025 (DE) 10 2025 103 681.0

(51) Int. Cl. B65G 43/08; B65B 7/28; B65B 35/24; B65B 57/04; B65G 47/44; B65G 47/51; B66F 9/06

(52) U.S. Cl. CPC B65G 43/08; B65B 7/2807; B65B 35/24; B65B 57/04; B65G 47/44; B65G 47/5104; B66F 9/063; B65G 2201/0235

(57) ABSTRACT

The invention relates to a container treatment facility comprising a plurality of container treatment apparatuses for treating the containers and a container transporting system that connects the plurality of container treatment apparatuses to one another for transporting the containers. The container treatment facility further comprises a collecting discharging conveyor having a circulating conveying element for supporting discharged containers from below and a plurality of container discharging devices that connect the collecting discharging conveyor to a plurality of discharging points of the container transporting system for receiving containers discharged from each of the discharging points of the container transporting system.

### CROSS REFERENCE TO RELATED APPLICATIONS

This application claims the benefit under 35 U.S.C. §119(a) of German Patent Application No. DE 10 2025 103 681.0, filed January 31, 2025, CONTAINER TREATMENT FACILITY WITH CONTAINER DISCHARGE FUNCTIONALITY, and whose entire disclosure is incorporated by reference herein.

### TECHNICAL FIELD

The invention relates to a container treatment system.

### BACKGROUND OF THE INVENTION

In modern container treatment facilities, such as beverage bottling facilities, container discharging apparatuses play a crucial role. These apparatuses serve to ensure the smooth operation of the facility by removing defective containers or those that do not meet quality standards from the production flow.

The construction of a container discharging apparatus can comprise a plurality of components, such as sensor(s) for fault recognition, a control device for processing sensor data, and actuator(s) that physically carries/carry out the discharging process (removal process). The sensors can record various types of errors, such as damage, incorrect fill levels, or labeling errors. Once a faulty container is identified, the control device can, for example, send a signal to the actuators that remove the container from the production flow.

Traditionally, discharged containers can fall into decentralized boxes or onto the ground. The fill level of the boxes can be recorded using counters. The boxes must be emptied by the operator when they reach a corresponding fill level.

A disadvantage of this conventional technique is that, in particular at high capacities and the associated increased number of container discharging apparatuses, the boxes have to be emptied very frequently by the operator. If the operator does not arrive in time to empty the boxes, the particular machine stops production. Frequent emptying ties up employees and increases troubleshooting time. In some cases, the boxes are emptied too late or not at all, resulting in a production outage. The fill level must be manually reset to ensure uninterrupted production. Sometimes, considerable construction effort is also required to be able to arrange and remove the boxes safely and to ensure access to the machine. In the event of a defect or malfunction, the discharged containers may back up in certain applications. This backlog can build up to the discharging point on the conveyor and thus lead to a collision with the conveyor.

WO 2016/075398 A1 relates to a facility for producing containers from preforms made of thermoplastic material. The facility comprises a grinding apparatus integrated into the facility for grinding the containers and the preforms removed by at least one removal apparatus.

The object addressed by the invention is that of providing a container treatment facility with improved container discharge functionality. Ideally, the container treatment facility should overcome at least some of the disadvantages mentioned above.

### SUMMARY OF THE INVENTION

The object is achieved by the features of independent claim 1. Advantageous developments are specified in the dependent claims and the description.

An aspect relates to a container treatment facility. The container treatment facility has a plurality of (e.g., rotary) container treatment apparatuses (e.g., container producing apparatus and/or container labeling apparatus and/or container filling apparatus(es) and/or container closing apparatus(es)) for treating the containers. The container treatment facility has a container transporting system that connects the plurality of container treatment apparatuses to one another for transporting the containers. The container treatment facility furthermore has a (e.g., linear) collecting discharging conveyor with a circulating conveying element (e.g., conveyor band, mat-top chain, etc.) for supporting discharged (e.g., defective or backing up) containers from below. The container treatment facility also has a plurality of container discharging devices that connect the collecting discharging conveyor to a plurality of (e.g., two, three, four or more) discharging points of the container transporting system in order to receive containers discharged from each of the discharging points of the container transporting system.

This technique has the advantage of reducing operator intervention due to the larger buffer capacity provided by the collective discharge ability. This can therefore advantageously significantly reduce machine downtimes. Collection containers at the end of the collecting discharging conveyor can be much larger and can also be easily accessibly arranged in a central position in the container treatment facility. The option of further automation can also be advantageously provided, for example through driverless transport vehicles that can pick up the discharged containers outside the container treatment apparatuses, for example at one end of the collecting discharging conveyor. This advantageously also means less outlay for the safe construction of the container treatment apparatuses and the container transporting system, including with regard to allowing access to the machines.

In an exemplary embodiment, at least one of the following is fulfilled:

the plurality of container discharging devices are connected to the collecting discharging conveyor at a distance from one another;

the plurality of discharging points are spaced apart from one another;

some, or each, of the plurality of container discharging devices have an actuable discharging element, preferably a pusher, plunger or slider, for discharging (e.g., defective) containers from the container transporting system; and

some, or each, of the plurality of container discharging devices have a chute for the discharged containers to descend, preferably for sliding onto the circulating conveying element of the collecting discharging conveyor.

Advantageously, the chutes can be used to retain the kinetic energy of the discharged containers, if possible, in order to keep the discharging points clear and prevent backlog (backflow).

Preferably, at least one of the discharging points or at least one of the discharging elements can be assigned a sensor system for detecting the containers and a control device for actuating each discharging point or each discharging element in order to discharge a container from a normal container flow (from the container transporting system) on the basis of a signal output by the sensor system, which indicates, for example, a defective container.

For example, the container transporting system has at least one of:

an infeed conveyor, preferably an infeed starwheel, wherein the infeed conveyor is arranged for supplying preforms to a heating device and has one of the plurality of discharging points;

an infeed conveyor, preferably an infeed starwheel, wherein the infeed conveyor is arranged for supplying preforms to a container producing apparatus and has one of the plurality of discharging points;

an outlet conveyor, preferably an outlet starwheel, wherein the outlet conveyor is arranged for transporting containers from a container producing apparatus and has one of the plurality of discharging points;

a connecting conveyor, preferably a connecting transport starwheel, wherein the connecting conveyor is arranged for transporting containers to a container labeling apparatus and has one of the plurality of discharging points;

a connecting conveyor, preferably a connecting transport starwheel, wherein the connecting conveyor is arranged for transporting containers from a container labeling apparatus and has one of the plurality of discharging points;

a distribution conveyor, preferably a distribution transport starwheel, wherein the distribution conveyor is arranged to divide containers between a first container filling apparatus and a second container filling apparatus and has one of the plurality of discharging points;

a connecting conveyor, preferably a connecting transport starwheel, wherein the connecting conveyor connects a (e.g., the first) container filling apparatus and a (e.g. first) container closing apparatus and has one of the plurality of discharging points;

a connecting conveyor, preferably a connecting transport starwheel, wherein the connecting conveyor connects the second container filling apparatus and a second container closing apparatus and has one of the plurality of further discharging points;

an output conveyor, preferably a linear output conveyor, wherein the output conveyor is connected to a (e.g., the first) container closing apparatus for receiving closed containers and has one of the plurality of discharging points; and

an output conveyor, preferably a linear output conveyor, wherein the output conveyor is connected to the second container closing apparatus for receiving closed containers and has one of the plurality of further discharging points.

The techniques disclosed herein regarding the collective discharge of containers can therefore be advantageously applied to a variety of different, combinable application scenarios.

In another embodiment, the container treatment facility also has a collecting container which is connected to the collecting discharging conveyor for receiving the discharged (e.g., uncrushed or crushed) containers. Preferably, the collecting container can be connected to a press for compacting the discharged (e.g., uncrushed or crushed) containers. Optionally, the container treatment facility can also comprise a crushing device for crushing the discharged containers. For example, the crushing device can be connected to the collecting discharging conveyor for receiving the discharged containers and to the collecting container for dispensing the crushed containers to the collecting container. Alternatively or in addition to the crushing device, it is possible, for example, that the container treatment facility also has a driverless transport vehicle configured to transport the collecting container. In this way, centralized and simplified, preferably automated, disposal of the discharged containers can advantageously be provided. Crushing the containers can not only reduce volume, but advantageously also weight, as the medium can drain out of containers that have already been filled.

In an embodiment, the plurality of container treatment apparatuses include a container closing apparatus for closing the containers with container closures. The container closing apparatus has a closure discharging device for discharging defective or unused container closures. The closure discharging device is connected to the collecting discharging conveyor for discharging the defective or unused container closures to the collecting discharging conveyor, preferably via one (e.g., chute) of the plurality of container discharging devices. Advantageously, the collecting discharging conveyor can also be used in this way to discharge discharged container closures.

In a further embodiment, at least one of the plurality of container discharging devices has a (e.g., tipping) discharging conveyor with a circulating conveying element (e.g., conveyor band, mat-top chain) for supporting the discharged containers from below. Preferably, the discharging conveyor can be pivotable (swivelable) (e.g., manually or driven by a motor), e.g., about a horizontal axis in order to pivot (swivel) the discharging conveyor up into a non-operating position to make it possible to pass the discharging conveyor when entering the container treatment facility. This can advantageously allow improved access to the machines in the facility.

In a variant, at least one of the container discharging devices has a pivotable (swivelable) flap with which the discharged containers can be guided either to the collecting discharging conveyor or to a collecting box, preferably below the pivotable (swivelable) flap. Preferably, at least one of the following conditions can also be met:

the pivotable (swivelable) flap is driven to pivot (swivel) by an (electric) motor,

the pivotable (swivelable) flap can be pivoted (swiveled)) (e.g., about a horizontal pivot (swivel) axis) into a pivoted (swiveled) position in which it covers the circulating conveying element of the collecting discharging conveyor and releases a container path to the collecting box;

- the pivotable (swivelable) flap can be pivoted (swiveled) (e.g., about a horizontal pivot (swivel) axis) into a (e.g., further) pivoted (swiveled) position in which it releases the circulating conveying element of the collecting discharging conveyor and blocks a container path to the collecting box; and

the container discharging device, which comprises the pivotable (swivelable) flap, is assigned to a container producing apparatus of the plurality of container treatment apparatuses.

For example, it is advantageous to be able to remove discharged containers from the collecting box for inspection or quality control purposes, if desired, thereby allowing for direct assignment to each of the container discharging devices and thus to each of the discharging points.

In another variant, the plurality of container discharging devices have at least one backlog discharging device (e.g., comprising a chute) configured to discharge containers that have backed up in the container transporting system to the collecting discharging conveyor. Preferably, at least one of the following conditions can also be met:

the backlog discharging device is located beside the container transporting system and the collecting discharging conveyor;

the backlog discharging device opens in a funnel shape toward the container transporting system; and

the container transporting system is arranged (e.g., directly) above the collecting discharging conveyor in the region of the backlog discharging device.

This advantageously makes it possible to prevent, in a relatively simple way, the build-up of a backlog of containers that have not been discharged up to, for example, transport starwheels or container treatment apparatuses, thus preventing collisions, for example.

In an embodiment, at least one of the plurality of container discharging devices has a deflection device (e.g., a servomotor deflection device), preferably a pneumatic or electric motor-driven one, which is configured to act on containers transported by each of the container discharging devices in order to deflect them away from each container discharging device, preferably causing them to fall down from each container discharging device (e.g., onto the ground or into a box next to the container discharging device). Furthermore, a sensor device for detecting a container backlog (backflow) on each of the container discharging devices and optionally a control device configured to operate the deflection device on the basis of a signal output by the sensor device may preferably be included. Preferably, the deflection device is arranged adjacently to a container free fall region of each container discharging device for acting on the containers during free fall. Preferably, the container free fall region can be connected to an outlet of a chute of each container discharging device. This advantageously makes it possible to prevent, in a relatively simple way, the build-up of a backlog of discharged containers up to, for example, transport starwheels or container treatment apparatuses, thus preventing collisions, for example.

Preferably, the term “control device” can refer to an electronic system (e.g., embodied as a driver circuit or with microprocessor(s) and data memory) and/or a mechanical, pneumatic, and/or hydraulic controller, which can take over open-loop control tasks and/or closed-loop control tasks and/or processing tasks, depending on the configuration. Although the term “control” is used herein, this can also comprise or be understood as “closed-loop control” or “control with feedback” and/or “processing” as appropriate. The control device can, for example, be a central control device or have a plurality of decentralized or distributed control devices.

In a further embodiment, the container treatment facility also has a (e.g., partial or full) housing in which at least one of the plurality of container treatment apparatuses, preferably a container producing apparatus and/or at least one container filling apparatus and/or at least one container closing apparatus, is/are arranged. Preferably, the housing can have a passage (for passing through the enclosure). Preferably, a container conveyor (e.g., a linear or rotary one) of the container transporting system and the collecting discharging conveyor (both) pass through the (same) passage. Advantageously, a passage in the housing that is provided for the container conveyor in any case can therefore be used by the collecting discharging conveyor so that the configuration of the housing is not complicated by the arrangement of the collecting discharging conveyor and hardly needs to be modified, if at all, for example.

In an embodiment, at least one of the following also is met:

the collecting discharging conveyor runs in parallel with the container conveyor in the region of the passage, preferably in parallel beside, in parallel above or in parallel below the container conveyor;

the collecting discharging conveyor and the container conveyor share a common support frame; and

the container conveyor is arranged above the collecting discharging conveyor, and one of the plurality of container discharging devices is a backlog discharging device (e.g., with a chute) that is connected to the collecting discharging conveyor for discharging containers backing up on the container conveyor to the collecting discharging conveyor.

This advantageously allows for a further simplification and improvement of the configuration and arrangement of the collecting discharging conveyor.

In another embodiment, the plurality of container treatment apparatuses comprise a (e.g., rotary) container producing apparatus, preferably a container blow-molding apparatus, which is arranged, for example, in the housing. The container transporting system preferably also features:

an infeed conveyor, preferably an infeed conveyor starwheel, wherein the infeed conveyor is arranged in the housing, has one of the plurality of discharging points and is connected to the container producing apparatus for conveying preform containers to the container producing apparatus; and/or

an outlet conveyor, preferably an outlet transport starwheel, wherein the outlet conveyor is arranged in the housing, has another of the plurality of discharging points and is connected to the container producing apparatus for transporting containers away from the container producing apparatus.

Preferably, the container conveyor passing through the passage can be a preform container conveyor arranged upstream of the infeed conveyor in terms of the container flow.

In an embodiment, the container treatment facility also comprises an additional (e.g., linear) collecting discharging conveyor with a circulating conveying element (e.g., conveyor band, mat-top chain, etc.) for supporting discharged containers from below. The container treatment facility may also have a plurality of additional container discharging devices that connect the further collecting discharging conveyor to a plurality of further discharging points of the container transporting system for receiving containers discharged from each further discharging point of the container transporting system. Preferably, at least one of the following conditions can also be met:

the plurality of further container discharging devices connected to the further collecting discharging conveyor at a distance from one another;

the plurality of further discharging points are spaced apart from one another;

some, or each, of the plurality of further container discharging devices have an actuable discharging element, preferably a pusher, plunger or slider, for discharging (e.g., defective) containers from the container transporting system; and

each, or some, of the plurality of further container discharging devices have a chute for the discharged containers to descend, preferably to descend onto the circulating conveying element of the further collecting discharging conveyor.

In this way, it is advantageously possible, for example, for high-capacity facilities, such as those with two container filling apparatuses and two container closing apparatuses, to utilize the techniques proposed herein regarding collective discharge, namely with two separate collecting discharging paths, realized by the two collecting discharging conveyors.

In another variant, the housing has an additional passage, and another container conveyor of the container transporting system and the further collecting discharging conveyor (both) pass through the additional passage. Preferably, at least one of the following conditions can also be met:

the further collecting discharging conveyor runs in parallel with the further container conveyor in the region of the further passage, preferably in parallel beside, in parallel above or in parallel below the further container conveyor;

the further collecting discharging conveyor and the additional container conveyor share a common support frame;

the further container conveyor is arranged above the further collecting discharging conveyor, and one of the plurality of further container discharging devices is a backlog discharging device (e.g., with a chute) that is connected to the further collecting discharging conveyor for discharging containers backing up on the further container conveyor to the further collecting discharging conveyor.

In an embodiment, the plurality of container treatment apparatuses comprise a first (e.g., rotary) container filling apparatus, a second (e.g., rotary) container filling apparatus, a first (e.g., rotary) container closing apparatus, and a second (e.g., rotary) container closing apparatus, which are preferably arranged in the housing.

In a further exemplary embodiment, at least one of the following conditions is also met:

the container transporting system has a distribution conveyor, preferably a distribution transport starwheel, which is arranged, for example, in the housing for dividing containers between the first container filling apparatus and the second container filling apparatus and/or has one of the plurality of discharging points;

the container transporting system has a first connecting conveyor, preferably a connecting transport starwheel, which is arranged, for example, in the housing and connects the first container filling apparatus and the first container closing apparatus and/or has one of the plurality of discharging points;

the container transporting system has a second connecting conveyor, preferably a connecting transport starwheel, which is arranged, for example, in the housing and connects the second container filling apparatus and the second container closing apparatus and/or has one of the plurality of further discharging points;

the container transporting system has a first output conveyor, preferably a linear output conveyor, which is arranged, for example, in the housing, is connected to the first container closing apparatus for receiving closed containers and/or has one of the plurality of discharging points (wherein the first output conveyor is preferably the container conveyor passing through the passage);

the container transporting system has a second output conveyor, preferably a linear output conveyor, which is arranged, for example, in the housing, is connected to the second container closing apparatus for receiving closed containers and/or has one of the plurality of further discharging points (wherein the second output conveyor is preferably the further container conveyor passing through the further passage);

the first container closing apparatus has a closure discharging device for discharging defective or unused container closures, which is connected, for example, to the collecting discharging conveyor for discharging the defective or unused container closures to the collecting discharging conveyor (e.g., via a chute of one of the container discharging devices); and

the second container closing apparatus has a closure discharging device for discharging defective or unused container closures, which is connected, for example, to the further collecting discharging conveyor for discharging the defective or unused container closures to the further collecting discharging conveyor (e.g., via a chute of one of the further container discharging devices).

For example, the containers can be realized as bottles, cans, canisters, cartons, vials, tubes, etc.

The preferred embodiments and features of the invention described above can be combined with one another as desired.

### BRIEF DESCRIPTION OF THE FIGURES

Further details and advantages of the invention are described below with reference to the accompanying drawings, in which:

FIG. 1 shows a schematic plan view of a container treatment facility in accordance with an embodiment;

FIG. 2 shows a schematic plan view of a container treatment facility in accordance with another embodiment;

FIG. 3 shows a schematic plan view of a container treatment facility in accordance with another different embodiment;

FIG. 4 shows a detailed perspective view of a portion of the container treatment facility in FIG. 3; and

FIG. 5 shows a schematic view of an example container discharging device.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

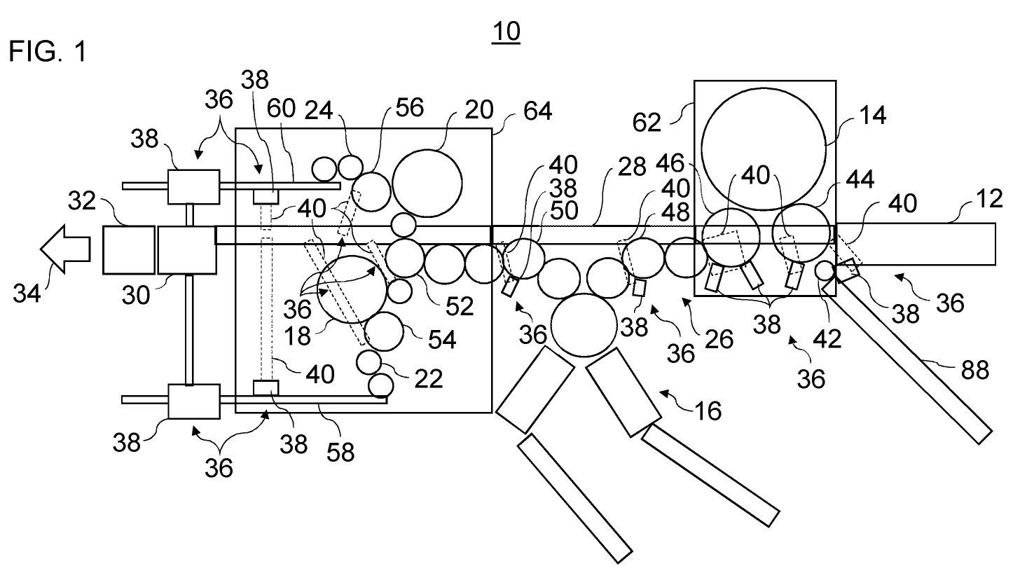

FIG. 1 shows a container treatment facility 10.

The container treatment facility 10 has a plurality of container treatment apparatuses 12–24, a container transporting system 26, a collecting discharging conveyor 28 and a plurality of container discharging devices 36. Optionally, the container treatment facility 10 can, for example, also comprise a crushing device 30 and/or a collecting container 32 and/or at least one housing 62, 64.

The container treatment apparatuses 12–24 can each be configured, for example, as a rotary container treatment apparatus or as a linear container treatment apparatus.

For example, the container treatment facility 10 can have at least one of the following as container treatment apparatuses: a heating apparatus 12, a container producing apparatus 14, a container labeling apparatus 16, a container filling apparatus 18, a container filling apparatus 20, a container closing apparatus 22 and a container closing apparatus 24.

The heating apparatus 12 can heat preforms (container blanks) to a desired temperature. For example, the container transporting system 26 can transport preforms to the heating apparatus 12 and transport heated preforms away from the heating apparatus 12.

The container producing apparatus 14 can manufacture containers from preforms. For example, the container transporting system 26 can transport preforms (preform containers) to the container producing apparatus 14 and transport containers away from the container producing apparatus 14.

Preferably, the container producing apparatus can be configured as a container blow-molding apparatus, preferably a stretch blow-molding apparatus, for blow-molding the containers from the preforms. The container producing apparatus is preferably configured as a container production carousel. The container producing apparatus can have a plurality of producing stations, e.g., blow-molding stations, for producing a plurality of containers simultaneously or with a temporal overlap. For example, the production stations can be arranged around a circumference of the container producing apparatus configured as a container production carousel. The container producing apparatus can be arranged downstream of the heating apparatus 12 in relation to the container flow.

The container labeling apparatus 16 can label the containers, e.g., with self-adhesive labels, cold glue labels or roll labels. For example, the container transporting system 26 can transport containers to the container labeling apparatus 16 and transport labeled containers away from the container labeling apparatus 16.

The container labeling apparatus 16 can preferably be configured as a rotary labeling apparatus. The container labeling apparatus 16 can, for example, have a plurality of rotatable container receptacles (e.g., container turntables) for the containers that are arranged around the circumference of a carousel of the rotary labeling apparatus. The container receptacles together with the containers received therein or thereon can be moved past at least one labeling unit of the container labeling apparatus 16. For example, two labeling units may be included, as shown schematically in FIG. 1. The at least one labeling unit can, for example, be arranged on a periphery of the rotary labeling apparatus. The container labeling apparatus 16 can be arranged downstream of the container producing apparatus 14 in relation to the container flow.

The container filling apparatuses 18, 20 can fill the containers, preferably with a liquid or pasty medium (e.g., a beverage). It is possible that only one container filling apparatus 18 or 20 is included. The container filling apparatuses 18, 20 are preferably configured as rotary filling apparatuses. For example, the container transporting system 26 can transport containers to the container filling apparatus 18 and/or 20 and transport full containers away from the container filling apparatus 18 and/or 20.

The container filling apparatuses 18, 20 can, for example, have a plurality of filling stations for filling a plurality of containers at the same time or with a temporal overlap. For example, the filling stations can be distributed around the circumference of a filler carousel of each rotary filling apparatus. The container filling apparatuses 18, 20 can be arranged downstream of the container labeling apparatus 16 in relation to the container flow.

The container closing apparatuses 22, 24 can close the containers, for example with a lid, a cork, a crown cap or a screw cap. It is possible that only one container closing apparatus 22 or 24 is included. For example, the container transporting system 26 can transport containers to the container closing apparatus 22 and/or 24 and transport closed containers away from the container closing apparatus 22 and/or 24.

The container closing apparatuses 22, 24 can preferably be configured as rotary closing apparatuses. The container closing apparatuses 22, 24 can have a plurality of closure stations for closing a plurality of containers either simultaneously or with a temporal overlap. For example, the closure stations can be distributed around the circumference of a closure carousel of each rotary closing apparatus. The container closing apparatuses 22, 24 can be arranged downstream of the container filling apparatuses 18, 20 in relation to the container flow.

The container transporting system 26 connects the container treatment apparatuses 12, 14, 16, 18, 20, 22 and/or 24 (if present) for transporting the containers. The container transporting system 26 can transport the containers through the container treatment facility 10, e.g., on one or more paths. The container transporting system 26 can, for example, have at least one transport starwheel and/or at least one linear conveyor.

The collecting discharging conveyor 28 is used to transport containers that have been discharged from the container transporting system 26 by the plurality of container discharging devices 36.

The collecting discharging conveyor 28 has a circulating conveying element. The circulating conveying element can support discharged containers from below when transporting them. The containers can be placed in a random arrangement on the circulating conveying element during transport. The conveying element can be, for example, a conveyor band, a belt, a strap or a mat-top chain.

Preferably, the collecting discharging conveyor 28 is a linear conveyor. It is possible that more than one collecting discharging conveyor 28 is included.

In general, the collecting discharging conveyor 28 can be implemented using different basic conveyor technology principles. The collecting discharging conveyor 28 can be divided into a plurality of portions, wherein the discharged containers can be transferred from one conveyor subsystem to the next. In addition to the aforementioned continuous conveyor by the circulating conveying element, worms and other conceivable systems can also be used, for example.

For example, the collecting discharging conveyor 28 can be connected to a crushing device 30 and/or to a collecting container 32.

The crushing device 30 can receive containers discharged by the collecting discharging conveyor 28. The crushing device 30 can crush the received containers, for example by shredding or grinding them. Preferably, the crushing device 30 can be connected to the collecting container 32. For example, the crushed containers can be passed from the crushing device 30 to the collecting container 32.

The collecting container 32 can accept and receive containers discharged from the collecting discharging conveyor 28 and/or crushed containers from the crushing device 30. Preferably, the collecting container 32 has a receiving volume for the discharged containers of ≥ 1 m^3, ≥ 1.5 m^3 or ≥ 2 m^3.

It is possible that the collecting container 32 is connected to a press for compacting the received containers. For example, the press can compact the discharged containers directly within the collecting container 32.

Preferably, a vertical conveyor can be integrated into the collecting discharging conveyor 28 adjacently to the collecting container 32 for dropping the discharged containers into the collecting container 32.

Preferably, the collecting container 32 can be replaceable. For example, a collecting container 32 filled with discharged containers can be replaced by an empty collecting container 32.

Preferably, the collecting container 32 can be transported away when it is full. For example, the collecting container 32 can be transported away by a driverless transport vehicle (AGV – automated guided vehicle) 34.

The container discharging devices 36 connect a plurality of discharging points of the container transporting system 26 with the collecting discharging conveyor 28. The collecting discharging conveyor 28 receives the containers discharged at the discharging points of the container transporting system 26 via the container discharging devices 36. The discharging points can be spaced apart along a route of the container transporting system 26. Preferably, the container discharging devices 36 are spaced apart and connected to the collecting discharging conveyor 28.

The container discharging devices 36 may preferably each have a discharging element 38 and/or a chute 40. It is possible, for example, that a plurality of container discharging devices 36 share a chute 40. It is also possible that a container discharging device 36, for example, has its own conveyor, e.g., with a circulating conveying element, for transporting discharged containers from each discharging point to the collecting discharging conveyor 28 (not shown in FIG. 1).

The discharging elements 38 can each be assigned to a discharging point of the container transporting system 26. A discharging element 38 can be configured to discharge containers from the container flow at each of the discharging points of the container transporting system 26.

The discharging elements 38 can be active or passive elements, for example.

An active discharging element 38 can actively discharge containers at each of the discharging points of the container transporting system 26. For example, an active discharging element 38 can be actuable in order to discharge a container at each of the discharging points of the container transporting system 26, e.g., actuated by a motor, actuated mechanically or actuated fluidically (e.g., pneumatically). For example, an active discharging element 38 can be configured as a plunger (pusher) or a slider.

For example, an inspection unit, preferably a sensor-based one, of each container discharging device 36 can detect the containers. On the basis of a signal output by the inspection unit, the active discharging element 38 can be actuated to discharge a container that has been recorded as being faulty, for example, by sensors.

A passive discharging element 38 can passively discharge containers at each of the discharging points of the container transporting system 26. For example, in the event of the containers backing up to the corresponding discharging point, a passive discharging element 38 can be configured to receive containers and discharge the received containers. For example, a passive discharging element 38 can be configured as a (backlog) container overflow.

Containers discharged by a container discharging device 36 can descend a chute 40 of the container discharging device 36. Preferably, the discharged containers can descend directly onto the circulating conveying element of the collecting discharging conveyor 28. However, it is also possible that the discharged containers descend, for example, onto a conveyor of the container discharging device 36, which in turn can convey the discharged containers to the circulating conveying element of the collecting discharging conveyor 28.

FIG. 1 shows an example of a variety of container discharging devices 36 that connect different discharging points of the container transporting system 26 to the collecting discharging conveyor 28.

For example, a container discharging device 36 can be arranged at a discharging point of an infeed conveyor 42 of the container transporting system 26. The infeed conveyor 42 can be arranged to transport preforms to the heating apparatus 14. The infeed conveyor 42 can, for example, be configured as a transport starwheel, particularly preferably a sawtooth starwheel.

As another example, a container discharging device 36 can be arranged at a discharging point of an infeed conveyor 44 of the container transporting system 26. The infeed conveyor 44 can be arranged to transport heated preforms to the container producing apparatus 14. The infeed conveyor 44 can be configured as a transport starwheel, preferably an infeed starwheel, for example.

As another example, a container discharging device 36 can be arranged at a discharging point of an outlet conveyor 46 of the container transporting system 26. The outlet conveyor 46 can be arranged for transporting containers away from the container producing apparatus 14. The outlet conveyor 46 can be configured as a transport starwheel, preferably an outlet starwheel, for example.

It is possible that a container discharging device 36 is arranged at a discharging point of a connecting conveyor 48 of the container transporting system 26. The connecting conveyor 48 can, for example, transport containers to the container labeling apparatus 16. For example, the connecting conveyor 48 can transfer the transported containers to an infeed starwheel of the container labeling apparatus 16. The connecting conveyor 48 can be configured as a transport starwheel, for example.

It is also possible that a container discharging device 36 is arranged at a discharging point of a connecting conveyor 50 of the container transporting system 26. The connecting conveyor 48 can, for example, transport containers away from the container labeling apparatus 16. For example, the connecting conveyor 50 can accept the containers from an outlet starwheel of the container labeling apparatus 16. The connecting conveyor 50 can be configured as a transport starwheel, for example.

It is also possible that a container discharging device 36 is arranged at a discharging point of a distribution conveyor 52 of the container transporting system 26. The distribution conveyor 52 can, for example, divide received containers between the first container filling apparatus 18 and the second container filling apparatus 20, preferably in a ratio of 50:50. It is possible that the ratio is adjustable. For example, the distribution conveyor 52 can be connected to an infeed starwheel of the first container filling apparatus 18 and to an infeed starwheel of the second container filling apparatus 18 in a manner in which it can be uncoupled therefrom. The distribution conveyor 52 can be realized as a distribution transport starwheel, for example.

For example, a container discharging device 36 can be arranged on a connecting conveyor 54 of the container transporting system 26. The connecting conveyor 54 can connect the first container filling apparatus 18 and the first container closing apparatus 22. The connecting conveyor 54 can transport full containers from the first container filling apparatus 18 to the first container closing apparatus 22. The connecting conveyor 54 can be configured as a transport starwheel, for example.

As another example, a container discharging device 36 can be arranged on a connecting conveyor 56 of the container transporting system 26. The connecting conveyor 56 can connect the second container filling apparatus 20 and the second container closing apparatus 24. The connecting conveyor 56 can transport full containers from the second container filling apparatus 20 to the second container closing apparatus 24. The connecting conveyor 56 can be configured as a transport starwheel, for example.

As another example, at least one container discharging device 36 can be arranged on an output conveyor 58 of the container transporting system 26. The output conveyor 58 can be arranged downstream of the first container closing apparatus 22 in terms of the container flow. For example, the output conveyor 58 can accept containers from an outlet starwheel of the first container closing apparatus 22. The output conveyor 58 can, for example, be a linear conveyor, preferably a single-track one. For example, the output conveyor 58 can have a circulating conveying element, such as a conveyor band, a belt, a strap or a mat-top chain, for supporting the containers at the bottom.

For example, a container discharging device 36 can have a discharging element configured as a container overflow, which discharges containers in the event of containers backing up on the output conveyor 58. For example, a further container discharging device 36 can have an inspection unit for testing the containers transported by the output conveyor 58 using sensors. Containers identified as faulty by the inspection unit can be discharged by an active discharging element 38 of the further container discharging devices 36.

As another different example, a container discharging device 36 can be arranged on an output conveyor 60 of the container transporting system 26. The output conveyor 60 can be arranged downstream of the second container closing apparatus 24 in terms of the container flow. For example, the output conveyor 60 can take containers from an outlet starwheel of the second container closing apparatus 24. The output conveyor 60 can, for example, be a linear conveyor, preferably a single-track conveyor. For example, the output conveyor 60 can have a circulating conveying element, such as a conveyor band, a belt, a strap or a mat-top chain, for supporting the containers at the bottom.

For example, a container discharging device 36 can have a discharging element configured as a container overflow, which discharges containers in the event of containers backing up on the output conveyor 60. For example, a further container discharging device 36 can have an inspection unit for testing the containers transported by the output conveyor 60 using sensors. Containers identified as faulty by the inspection unit can be discharged by an active discharging element 38 of the further container discharging devices 36.

The at least one housing 62, 64 can be a partial housing or a full housing. In the at least one housing 62, 64 at least one container treatment apparatus 14–24 can be arranged.

For example, the container producing apparatus 14 can be arranged in the housing 62. Additionally, the infeed conveyor 42, the infeed conveyor 44 and/or the outlet conveyor 46 can be arranged in the housing 62, for example.

For example, the container filling apparatus 18, the container filling apparatus 20, the container closing apparatus 22 and/or the container closing apparatus 24 can be arranged in the housing 64. Additionally, for example, the distribution conveyor 52, the connecting conveyor 54, the connecting conveyor 56, part of the output conveyor 58 and/or part of the output conveyor 60 may be arranged.

It is preferred that the housing 62 and/or 64 has a passage. A container conveyor of the container transporting system 26 and the collecting discharging conveyor 28 can preferably both pass through each passage.

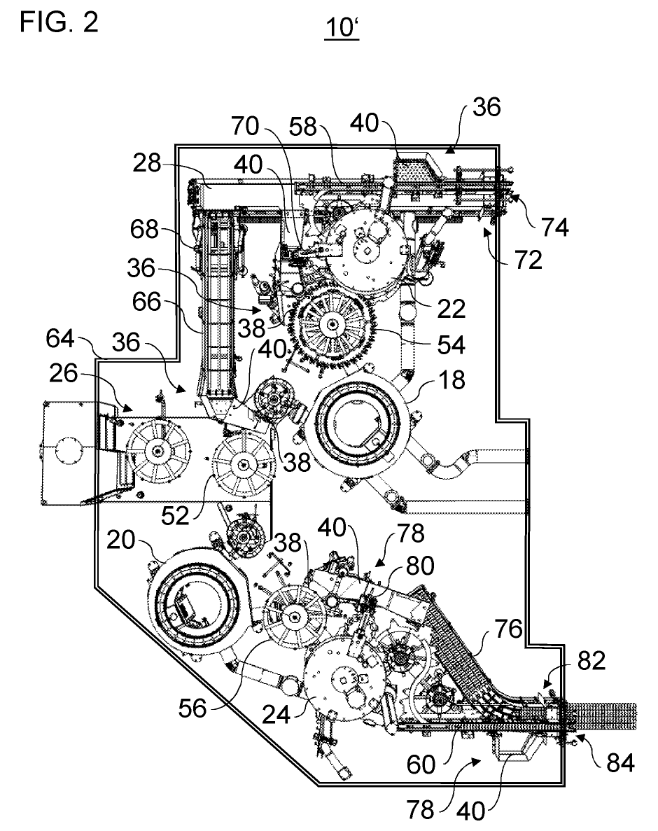

FIG. 2 shows a modified container treatment facility 10‘ with a collecting discharging conveyor 28 and optionally a further collecting discharging conveyor 76.

Preferably, the collecting discharging conveyor 28 can be connected to a discharging point of the distribution conveyor 52 via a container discharging device 36. This container discharging device 36 may preferably have a chute 40. From the chute 40, the discharged containers can descend onto a discharging conveyor 66.

The discharging conveyor 66 can connect the chute 40 to the collecting discharging conveyor 28. The discharging conveyor 66 can transport the discharged containers from the chute 40 to the collecting discharging conveyor 28.

Preferably, the discharging conveyor 66 can be a linear conveyor. For example, the discharging conveyor 66 can have a circulating conveying element, e.g., a conveyor band or mat-top chain. The circulating conveying element can support the discharged containers from below during transport.

The discharging conveyor 66 is preferably pivotable (swivelable). Preferably, the discharging conveyor 66 can be pivoted about a horizontal axis 68. For example, during pivoting, a support frame can be pivoted together with the circulating conveying elements. The support frame can, for example, carry a drive wheel and a deflection wheel, around which the conveying element circulates. For example, the discharging conveyor 66 can be pivotable by a motor or manually.

Preferably, the discharging conveyor 66 can be upwardly pivoted about the horizontal axis 68 into a non-operating position. In the upwardly pivoted non-operating position, the discharging conveyor 66 can be easily passed by personnel. For example, when entering the facility 10‘, access to the connecting conveyor 54, the container filling apparatus 18 and the container closing apparatus 22 can be made possible.

Conversely, the discharging conveyor 66 can be pivoted down about the horizontal axis 68 into a substantially horizontal operating position, as shown schematically in FIG. 2.

Preferably, the collecting discharging conveyor 28 can be connected to a discharging point of the connecting conveyor 54 via a container discharging device 36. This container discharging device 36 may preferably have a chute 40. From the chute 40, the discharged containers can descend onto the collecting discharging conveyor 28.

The first container closing apparatus 22 may preferably have a closure discharging device 70 for discharging container closures. For example, the closure discharging device 70 can be used to discharge defective or unused container closures, e.g., screw closures, from the first container closing apparatus 22.

The closure discharging device 70 can be connected to the collecting discharging conveyor 28 for discharging the container closures to the collecting discharging conveyor 28. For example, the closure discharging device 70 can discharge the container closures onto the chute 40 of one of the container discharging devices 36. The container closures can then descend this chute 40 to the collecting discharging conveyor 28.

Preferably, the output conveyor 58 can be arranged above the collecting discharging conveyor 28. Preferably, the collecting discharging conveyor 28 and the output conveyor 58 can share a common support frame 72. For example, the output conveyor 58 can be arranged directly above the collecting discharging conveyor 28.

The output conveyor 58 and the collecting discharging conveyor 28 can be connected to one another via a container discharging device 36. Preferably, this container discharging device 36 is a backlog discharging device. The backlog discharging device allows containers backing up on the output conveyor 58 to be discharged downward to the collecting discharging conveyor 28. Specifically, containers backing up on the output conveyor 58 can descend to the collecting discharging conveyor 28 via a chute 40 arranged beside the output conveyor 58. The backlog discharging device can open in a funnel shape toward the further output conveyor 58. The backlog discharging device can be arranged beside the collecting discharging conveyor 28 and the output conveyor 58.

Preferably, the collecting discharging conveyor 28 and the output conveyor 58 can both pass through a passage 74 of the housing 64 and exit the housing 64. At least in the region of the passage 74, the collecting discharging conveyor 28 and the output conveyor 58 can extend in parallel.

The further collecting discharging conveyor 76 serves to transport containers that have been discharged from the container transporting system 26 by a plurality of further container discharging devices 78.

In principle, the further collecting discharging conveyor 76 can be configured in the same way as the collecting discharging conveyor 28.

For example, the further collecting discharging conveyor 76 has a circulating conveying element. The circulating conveying element can support discharged containers from below when transporting them. The containers can be placed in a random arrangement on the circulating conveying element during transport. The conveying element can be, for example, a conveyor band, a belt, a strap or a mat-top chain.

Preferably, the further collecting discharging conveyor 76 is a linear conveyor.

For example, the further collecting discharging conveyor 76 can be connected to a/the crushing device and/or to a/the collecting container (not shown in FIG. 2).

The other container discharging devices 78 can in principle also be configured in the same way as the container discharging devices 36.

For example, the further container discharging devices 78 can connect a plurality of further discharging points of the container transporting system 26 to the further collecting discharging conveyor 76. The further collecting discharging conveyor 76 can receive the containers discharged at the further discharging points of the container transporting system 26 via the further container discharging devices 78. The further discharging points can be spaced apart along the route of the container transporting system 26. Preferably, the further container discharging devices 78 are spaced apart from one another and connected to the further collecting discharging conveyor 76.

Preferably, the further collecting discharging conveyor 76 can be connected to a discharging point of the connecting conveyor 56 via a further container discharging device 78. This further container discharging device 76 may preferably have a chute 40. From the chute 40, the discharged containers can descend onto the further collecting discharging conveyor 76.

The second container closing apparatus 24 may preferably have a closure discharging device 80 for discharging container closures. For example, the closure discharging device 80 can be used to discharge defective or unused container closures, e.g., screw closures, from the second container closing apparatus 24.

The closure discharging device 80 can be connected to the further collecting discharging conveyor 76 for discharging the container closures to the collecting discharging conveyor 76. For example, the closure discharging device 80 can discharge the container closures onto the chute 40 of one of the further container discharging devices 78. The container closures can then descend this chute 40 to the further collecting discharging conveyor 76.

Preferably, the further output conveyor 60 can be arranged above the further collecting discharging conveyor 76. Preferably, the further collecting discharging conveyor 76 and the further output conveyor 60 can share a common support frame 82. For example, the further output conveyor 60 can be arranged directly above the further collecting discharging conveyor 76.

The further output conveyor 60 and the further collecting discharging conveyor 76 can be connected to one another via a further container discharging device 78. Preferably, this further container discharging device 78 is a backlog discharging device. The backlog discharging device allows containers backing up on the further output conveyor 60 to be discharged downward to the further collecting discharging conveyor 76. Specifically, containers backed up on the further output conveyor 60 can descend a chute 40 arranged beside the further output conveyor 60 to the further collecting discharging conveyor 76. The backlog discharging device can open in a funnel shape toward the further output conveyor 60. The backlog discharging device can be arranged beside the further collecting discharging conveyor 76 and the further output conveyor 60.

Preferably, the further collecting discharging conveyor 76 and the further output conveyor 60 can both pass through another passage 84 of the housing 64 and leave the housing 64. At least in the region of the further passage 84, the further collecting discharging conveyor 76 and the further output conveyor 60 can extend in parallel.

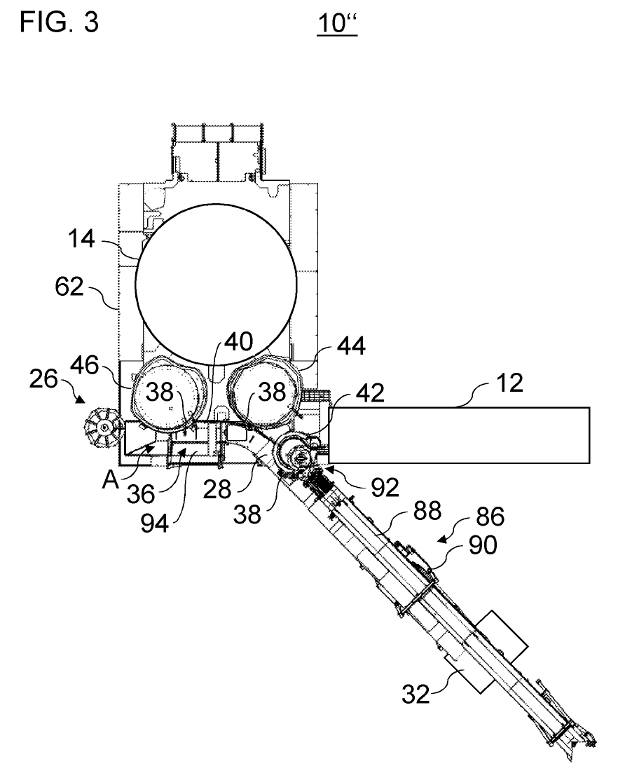

FIG. 3 shows another modified container treatment facility 10’’.

The container treatment facility 10’’ can have a preform container conveyor 86 with a preform linear conveyor 88 and the (preform) infeed conveyor 42.

The preform container conveyor 86 and the collecting discharging conveyor 28 can run side by side, at least in portions. Preferably, the collecting discharging conveyor 28 can extend at a slightly lower level than the preform container conveyor 86. Preferably, the collecting discharging conveyor 28 and the preform container conveyor 86 can share a common support frame 90.

Preferably, the preform container conveyor 86 and the collecting discharging conveyor 28 can both pass through a passage 92 of the housing 62 and exit the housing 62. At least in the region of the passage 92, the preform container conveyor 86 and the collecting discharging conveyor 28 can preferably extend in parallel.

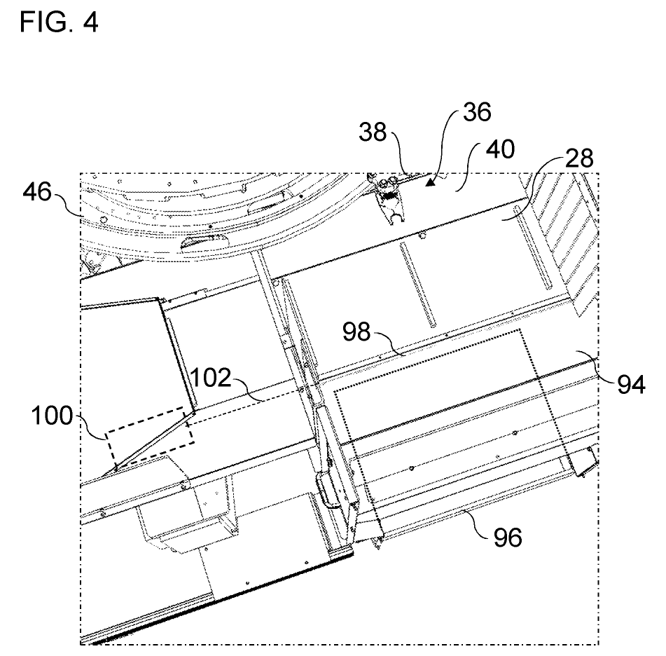

FIG. 4 shows detail A from FIG. 3 in a perspective view.

Preferably, the container discharging device 36 can have a pivotable (swivelable) flap 94. The container discharging device 36 is preferably the container discharging device that connects a discharging point of the outlet conveyor 46 to the collecting discharging conveyor 28 and/or connects a discharging point of the infeed conveyor 44 to the collecting discharging conveyor 28.

By means of the pivotable flap 94, containers discharged by the container discharging device 36 can be directed to either the collecting discharging conveyor 28 or to a collecting box 96. Preferably, the collecting box 96 may be arranged below the flap 94.

For example, the flap 94 can be pivotable into a first pivoted position, as shown in FIG. 4. In the first pivoted position, the flap 94 can, for example, release the circulating conveying element of the collecting discharging conveyor 28. Thus, containers discharged by the container discharging device 36 can land on the circulating conveying element of the collecting discharging conveyor 28 and be transported away. Preferably, the flap 94 in the first pivoted position can serve as a chute for containers to descend onto the circulating conveying element of the collecting discharging conveyor 28. Preferably, the flap 94 can block a container path to the collecting box 96.

For example, the flap 94 can be pivotable into a second pivoted position (not shown in FIG. 4). Preferably, in the second pivoted position, the flap 94 can cover the circulating conveying element of the collecting discharging conveyor 28. Preferably, in the second pivoted position, the flap 94 can release a container path to the collecting box 96. Thus, containers discharged by the container discharging device 36 can land on the flap 94 and be directed therefrom to the collecting box 96.

The flap 94 can, for example, be pivoted about a horizontal pivot axis 98. Preferably, the flap 94 can be pivoted about the horizontal pivot axis 98 between the first pivoted position and the second pivoted position.

Preferably, a drive unit 100, preferably an electric one, for pivoting the flap 94 can be drivingly connected to the flap 94. The drive unit 100 can be a rotary drive, for example. For example, the drive unit 100 can be drivingly connected to the flap 94 by a (pivot) shaft 102.

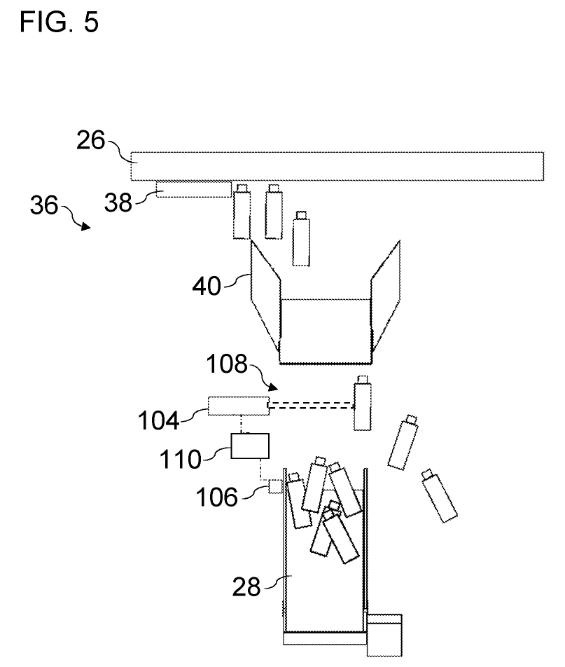

FIG. 5 schematically shows an example container discharging device 36.

The container discharging device 36 can comprise the chute 40, a deflection device 104, a sensor device 106 and a control device 110.

From one end of the chute 40, the discharged containers can preferably fall onto the circulating conveying element of the collecting discharging conveyor 28. Alternatively, the discharged containers could, for example, fall onto a discharging conveyor of the container discharging device (e.g., the discharging conveyor 66 – see FIG. 2).

The deflection device 104 can be configured to act on discharged containers transported from the container discharging device 36 such that they are deflected and exit the container discharging device 36. Preferably, the containers deflected in this way can then fall next to the container discharging device 36 or the collecting discharging conveyor 28, e.g., onto the floor or into a box.

For example, the deflection device 104 can be arranged adjacently to a container free fall region 108 of the container discharging device 36 for acting on the containers during free fall. The container free fall region 108 can, for example, be connected to an outlet (one end) of the chute 40.

Preferably, the deflection device 104 can be a pneumatic or electric motor-driven deflection device.

For example, the deflection device 104 can have a compressed air nozzle and a compressed air source. The compressed air source can be connected to the compressed air nozzle to supply compressed air to the compressed air nozzle. The compressed air nozzle can be arranged so that it can apply compressed air to containers transported from the container discharging device 36 to deflect them away from the container discharging device 36. For example, the compressed air nozzle can be arranged to discharge a jet of compressed air into the container free fall region 108.

For example, the deflection device can be driven by an electric motor, preferably a servomotor. For example, the deflection device can be a so-called servopusher.

Alternatively, a mechanical deflection device may be included, for example. This may, for example, have an adjustable diverter that can deflect the discharged containers when it is actuated accordingly.

The sensor device 106 can detect if the containers are backing up on each container discharging device 36. For example, the sensor device 106 can be an optical or a tactile sensor device. Preferably the sensor device 106 can comprise a light barrier or an ultrasonic sensor. The sensor device 106 can be arranged, for example, adjacently to the container free fall region 108 or an inlet of the collecting discharging conveyor 28 or a discharging conveyor of the container discharging device 36.

The control device 110 can operate the deflection device 104 on the basis of a signal output by the sensor device 106. For example, the control device 110 can operate the deflection device 104 to deflect containers when the signal output indicates a container backlog (backflow).

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed and can be claimed independently of all of the features of independent claim 1 and, for example, independently of the features of claim 1 relating to the presence and/or the configuration of the container treatment apparatuses, the container transporting system, the collecting discharging conveyor and/or the plurality of container discharging devices. All ranges specified herein are to be understood as disclosed and claimable in such a way that all values falling within the relevant range are individually disclosed, e.g., also as the relevant preferred narrower outer limits of the relevant range.

### LIST OF REFERENCE SIGNS

10 container treatment facility

12 heating apparatus

14 container producing apparatus

16 container labeling apparatus

18 (first) container filling apparatus

20 (second) container filling apparatus

22 (first) container closing apparatus

24 (second) container closing apparatus

26 container transporting system

28 collecting discharging conveyors

30 crushing device

32 collecting container

34 driverless transport vehicle

36 container discharging device

38 discharging element

40 chute

42 infeed conveyor

44 infeed conveyor

46 outlet conveyor

48 connecting conveyor

50 connecting conveyor

52 distribution conveyor

54 (first) connecting conveyor

56 (second) connecting conveyor

58 (first) output conveyor

60 (second/further) output conveyor

62 housing

64 housing

66 discharging conveyor

68 horizontal axis

70 closure discharging device

72 support frame

74 passage

76 (further) collecting discharging conveyor

78 (further) container discharging device

80 closure discharging device

82 (further) support frame

84 (further) passage

86 preform container conveyor

88 preform linear conveyor

90 support frame

92 passage

94 flap

96 collecting box

98 pivot axis

100 drive unit

102 shaft

104 deflection device

106 sensor device

108 container free fall region

110 control device

What is claimed is:

1. A container treatment facility, comprising:
a plurality of container treatment apparatuses for treating the containers;
a container transporting system that connects the plurality of container treatment apparatuses to one another for transporting the containers;
a collecting discharging conveyor having a circulating conveying element for supporting discharged containers from below; and
a plurality of container discharging devices that connect the collecting discharging conveyor to a plurality of discharging points of the container transporting system for receiving containers discharged from each of the discharging points of the container transporting system.

2. The container treatment facility according to claim 1, wherein at least one of the following is met:
the plurality of container discharge devices are connected to the collecting discharging conveyor at a distance from one another;
the plurality of discharging points are spaced apart from one another;
some, or each, of the plurality of container discharging devices have an actuable discharging element for discharging containers from the container transporting system; and
some, or each, of the plurality of container discharging devices have an actuable discharging element, which is a pusher, a plunger or a slider, for discharging containers from the container transporting system; and
some, or each, of the plurality of container discharging devices have a chute for the discharged containers to descend; and
some, or each, of the plurality of container discharging devices have a chute for the discharged containers to descend onto the circulating conveying element of the collecting discharging conveyor.

3. The container treatment facility according to claim 1, further comprising:
a collecting container which is connected to the collecting discharging conveyor for receiving the discharged containers,
wherein the container treatment facility further has at least one of the following:
a press for compacting the discharged containers, to which the collecting container is connected;
a crushing device for crushing the discharged containers, wherein the crushing device is connected to the collecting discharging conveyor for receiving the discharged containers and to the collecting container for dispensing the crushed containers to the collecting container; and
a driverless transport vehicle configured to transport the collecting container.

4. The container treatment facility according to claim 1, wherein:
the plurality of container treatment apparatuses have a container closing apparatus for closing the containers using container closures;
the container closing apparatus comprises a closure discharging device for discharging defective or unused container closures; and
wherein one of:
the closure discharging device is connected to the collecting discharging conveyor for discharging the defective or unused container closures to the collecting discharging conveyor; and
the closure discharging device is connected to the collecting discharging conveyor for discharging the defective or unused container closures to the collecting discharging conveyor via one of the plurality of container discharging devices.

5. The container treatment facility according to claim 1, wherein:
at least one of the plurality of container discharging devices has a discharging conveyor comprising a circulating conveying element for supporting the discharged containers from below; and
wherein one of:
the discharging conveyor is pivotable; and
the discharging conveyor is pivotable about a horizontal axis in order to pivot the discharging conveyor up into a non-operating position in order to pass the discharging conveyor when entering the container treatment facility.

6. The container treatment facility according to claim 1, wherein:
at least one of the container discharging devices has a pivotable flap with which the discharged containers can be guided selectively to the collecting discharging conveyor or to a collecting box.

7. The container treatment facility according to claim 1, wherein:
the plurality of container discharging devices have at least one backlog discharging device configured to discharge containers that have accumulated in the container transporting system to the collecting discharging conveyor.

8. The container treatment facility according to claim 1, wherein:
at least one of the plurality of container discharging devices has a deflection device, wherein the deflection device is configured to act on containers transported by a respective one of the container discharging devices to deflect them from the respective one of the container discharging devices;
a sensor device for detecting a container backlog on the respective one of the container discharging devices; and
a control device configured to operate the deflection device on the basis of a signal output by the sensor device.

9. The container treatment facility according to claim 1, further comprising:
a housing in which at least one of the plurality of container treatment apparatuses, is arranged,
wherein:
the housing has a passage; and
a container conveyor of the container transporting system and the collecting discharging conveyor pass through the passage.

10. The container treatment facility according to claim 9, wherein at least one of the following is also met:
the plurality of container treatment apparatuses comprises at least one of a container producing apparatus, a container filling apparatus, a container closing apparatus;
the collecting discharging conveyor runs in parallel with the container conveyor in a region of the passage;
the collecting discharging conveyor and the container conveyor share a common support frame; and
the container conveyor is arranged above the collecting discharging conveyor and one of the plurality of container discharging devices is a backlog discharging device which is connected to the collecting discharging conveyor for discharging containers backing up on the container conveyor to the collecting discharging conveyor.

11. The container treatment facility according to claim 9, wherein:
the plurality of container treatment apparatuses comprise a container producing apparatus, which is arranged in the housing; and
the container transporting system comprises:
an infeed conveyor, wherein the infeed conveyor is arranged in the housing, comprises one of the plurality of discharging points and is connected to the container producing apparatus for conveying preform containers to the container producing apparatus;
an outlet conveyor, wherein the outlet conveyor is arranged in the housing, comprises another of the plurality of discharging points and is connected to the container producing apparatus for transporting containers away from the container producing apparatus.

12. The container treatment facility according to claim 9, further comprising:
a further collecting discharging conveyor having a circulating conveying element for supporting discharged containers from below,
a plurality of further container discharging devices which connect the further collecting discharging conveyor to a plurality of further discharging points of the container transporting system for receiving containers discharged from each of the further discharging points of the container transporting system.

13. The container treatment facility according to claim 12, wherein:
the housing has a further passage; and
another container conveyor of the container transporting system and the further collecting discharging conveyor pass through the further passage.

14. The container treatment facility according to claim 12, wherein:
the plurality of container treatment apparatuses comprise a first container filling apparatus, a second container filling apparatus, a first container closing apparatus and a second container closing apparatus which are arranged in the housing.

15. The container treatment facility according to claim 14, wherein furthermore at least one of the following is also met:
the container transporting system has a distribution conveyor, wherein the distribution conveyor is arranged in the housing for dividing containers between the first container filling apparatus and the second container filling apparatus and has one of the plurality of discharging points;
the container transporting system has a first connecting conveyor, wherein the first connecting conveyor is arranged in the housing and connects the first container filling apparatus and the first container closing apparatus and comprises one of the plurality of discharging points;
the container transporting system has a second connecting conveyor, wherein the second connecting conveyor is arranged in the housing and connects the second container filling apparatus and the second container closing apparatus and comprises one of the plurality of further discharging points;
the container transporting system has a first output conveyor, wherein the first output conveyor is arranged in the housing, is connected to the first container closing apparatus for receiving closed containers and comprises one of the plurality of discharging points;
the container transporting system has a second output conveyor, wherein the second output conveyor is arranged in the housing, is connected to the second container closing apparatus for receiving closed containers and has one of the plurality of further discharging points;
the first container closing apparatus has a closure discharging device for discharging defective or unused container closures, which is connected to the collecting discharging conveyor for discharging the defective or unused container closures to the collecting discharging conveyor; and
the second container closing apparatus has a closure discharging device for discharging defective or unused container closures, which is connected to the further collecting discharging conveyor for discharging the defective or unused container closures to the further collecting discharging conveyor.

16. The container treatment facility according to claim 6, wherein at least one of:
the collecting discharging conveyor or to the collecting box is below the pivotable flap;
the pivotable flap is driven to pivot by a motor;
the pivotable flap can be pivoted into a pivoted position in which it covers the circulating conveying element of the collecting discharging conveyor and releases a container path to the collecting box;
the pivotable flap can be pivoted into a pivoted position in which it releases the circulating conveying element of the collecting discharging conveyor and blocks a container path to the collecting box; and
the container discharging device having the pivotable flap is assigned to a container producing apparatus of the plurality of container treatment apparatuses.

17. The container treatment facility according to claim 7, wherein at least one of:
the backlog discharging device is arranged beside the container transporting system and the collecting discharging conveyor;
the backlog discharging device opens in a funnel shape toward the container transporting system; and
the container transporting system is arranged above the collecting discharging conveyor in a region of the backlog discharging device.

18. The container treatment facility according to claim 8, wherein at least one of:
the deflection device is a pneumatic or electric motor driven;
the deflection device is configured to act on containers transported by a respective one of the container discharging devices to deflect them from the respective one of the container discharging devices to cause them to fall off from the respective one of the container discharging devices;
the deflection device is arranged adjacently to a container free fall region of the respective one of the container discharging devices for acting on the containers during free fall,
the container free fall region connects to an outlet of a chute of the respective one of the container discharging devices.

19. The container treatment facility according to claim 12, wherein at least one of:
the plurality of further container discharging devices are connected to the further collecting discharging conveyor at a distance from one another;
the plurality of further discharging points are spaced apart from one another;
some, or each, of the plurality of further container discharging devices have an actuable discharging element for discharging containers from the container transporting system;
some, or each, of the plurality of further container discharging devices have an actuable discharging element, which is a pusher, a plunger or a slider, for discharging containers from the container transporting system;
some, or each, of the plurality of further container discharging devices have a chute for the discharged containers to descend; and
some, or each, of the plurality of further container discharging devices have a chute for the discharged containers to descend onto the circulating conveying element of the further collecting discharging conveyor.

20. The container treatment facility according to claim 13, wherein at least one of:
the further collecting discharging conveyor runs in parallel with the further container conveyor in a region of the further passage;
the further collecting discharging conveyor runs in parallel beside, in parallel above or in parallel below the further container conveyor in a region of the further passage;
the further collecting discharging conveyor and the further container conveyor share a common support frame;
the further container conveyor is arranged above the further collecting discharging conveyor and one of the plurality of further container discharging devices is a backlog discharging device which is connected to the further collecting discharging conveyor for discharging containers backing up on the further container conveyor to the further collecting discharging conveyor.
